(19) United States
(12) Patent Application Publication
(10) Pub. No.: US 2005/0017498 A1
(43) Pub. Date: Jan. 27, 2005

(54) Pillar anchor and method for manufacturing the same

(76) Inventor: Jin Hee Kang, Seoul (KR)

Correspondence Address: CARSTENS YEE & CAHOON, LLP, P O BOX 802334, DALLAS, TX, 75380, US

(21) Appl. No.: 10/897,259

(22) Filed: Jul. 22, 2004

(30) Foreign Application Priority Data
Jul. 22, 2003 (KR) 10-2003-0050365

(51) Int. Cl. B60R 22/00

(52) U.S. Cl. 280/808

(57) ABSTRACT

The present invention relates to an improved pillar anchor and a method for manufacturing the same. According to the pillar anchor of the present invention described as above and the method for manufacturing the same, the rims of the pair of separated base plates abut each other, so that the surface in contact with the belt is formed in a “C”-shape. Thus, it is simple to manufacture the pillar anchor of the present invention, and moreover, the number of processes needed for manufacture is reduced. In addition, since the inner peripheral surfaces of the belt insertion holes around which the belt is wound are generally formed of only a steel plate, the friction coefficient between the belt and the inner peripheral surfaces of the belt insertion holes is reduced. Accordingly, when the belt is subjected to tension, damage caused from wear and tear of the belt due to the friction between the belt and the inner peripheral surfaces of the belt insertion holes is effectively reduced. Moreover, the belt can smoothly moves on the inner peripheral surfaces of the belt insertion holes.

### BACKGROUND OF THE INVENTION

1. Field of Invention

The present invention relates to an improved pillar anchor and a method for manufacturing the same. More particularly, the present invention relates to an improved pillar anchor for slidably engaging a seat belt to a stationary point such as a vehicle body in a seat belt apparatus for a vehicle and a method for manufacturing the same.

2. Description of the Prior Art

Generally, a seat belt, i.e. a web belt of a seat belt apparatus for a vehicle, is wound in a belt winding device when a user does not wear the web belt, and is pulled out from the belt winding device by the user in order to wear the web belt. As shown in FIG. 1, in a conventional seat belt apparatus for a vehicle, a proximal end of a fixing belt 72 is fixed to a buckle anchor 71 fixed to a vehicle body B at a side of a seat D, while a distal end of the fixing belt 72 is formed with a buckle 73. A retractor 75, which is the belt winding device, is fixed at a lateral face of the vehicle body B, and a pillar anchor 77 is fixed at the lateral face of the vehicle body B above the retractor 75. An end of the web belt S is fixed to the retractor 75, and an intermediate portion of the web belt S is provided with an engaging member 76 so that the engaging member 76 is detachably engaged to the buckle 73. The web belt S is connected to the retractor 75 through the pillar anchor 77. The other end of the web belt S is fixed to a mini anchor 79 which is fixed to a lower portion of the vehicle body B opposite to the buckle anchor 71 with the seat D interposed therebetween.

As shown in FIGS. 2a and 2b, the conventional pillar anchor 77 includes a base plate 80 of steel, which is divided into an attachment portion 80A and a belt protecting/supporting portion 80B. The attachment portion 80A is formed with an attachment hole 81, into which a bolt is inserted for fixing the conventional pillar anchor 77 to the vehicle body B, while the belt protecting/supporting portion 80B is formed with an elongated hole 82, for inserting the web belt S. In the base plate 80, the entire peripheral portion of the belt protecting/supporting portion 80B including the elongated hole 82 is covered with a coating member 90 of synthetic resin which is insert molded. Particularly, the inside of the elongated hole 82 is formed with a belt insertion hole 91, which comprises a first long peripheral portion 91a, a second long peripheral portion 91b, a first short peripheral portion 91c, and second short peripheral portion 91d of the coating member 90. The web belt S is slidably inserted through the belt insertion hole 91.

An arc-shaped sliding plate 93 of steel with a smooth surface is attached over the first long peripheral portion 91a, which the web belt S is folded over and is in contact with, in order for the web belt S to smoothly slide.

However, when synthetic resin is insert molded to the base plate 80, a structure for supporting the sliding plate 93 in an insert mold is necessary. Thus, there are problems in that it is very difficult to manufacture a conventional pillar anchor, and, there are many processes for the manufacture thereof.

In addition, although the long peripheral portion of an inner peripheral surface of the belt insertion hole around which the belt is wound is formed of the sliding plate of steel, the short peripheral portions of the inner peripheral surface of the belt insertion hole are formed by the coating member of synthetic resin. Thus, if an edge of the belt comes into contact with any one of the short peripheral portions of the belt insertion hole, friction is generated between the belt and the coating member when tension is generated in the belt. Accordingly, there are additional problems in that the belt not only is worn out and damaged by the inner peripheral surface of the belt insertion hole, but also does not smoothly move on the inner peripheral surface of the belt insertion hole.

### SUMMARY OF THE INVENTION

The present invention is conceived to solve the aforementioned problems in the conventional pillar anchor. Accordingly, an object of the present invention is to provide a pillar anchor which comprises a pair of separated base plates of steel abutting each other and is structured so that inner peripheral surfaces of belt insertion holes and outer peripheral surfaces of belt protecting/supporting portions form a belt contact portion and a gripping portion when the pair of separated base plates abut each other so that rims of the belt insertion holes and outer rims of the belt protecting/supporting portions of the respective separated base plates form curved surfaces, and a method for manufacturing the same.

According to a first aspect of the present invention for achieving the object, there is provided a pillar anchor, which a web belt is slidably hung on and supported by, comprising: a pair of separated base plates of steel abutting each other; wherein each of the pair of separated base plates comprises an attachment portion and a belt protecting/supporting portion; the attachment portion is formed with an attachment hole for attaching the pillar anchor to a vehicle body side; a rim of the attachment hole of any one of the pair of separated base plates is formed with an engaging projection projected toward its rear side by a burring process; a rim of the attachment hole of the other of the pair of separated base plates is formed with an engaging depressed portion by a forming process; the engaging projection of the attachment hole of the one of the pair of separated base plates and the engaging depressed portion of the attachment hole of the other of the pair of separated base plates are engaged to each other by a compressing process; the belt protecting/supporting portion is formed with an elongate belt insertion hole for inserting the belt; first and second long peripheral portions and first and second short peripheral portions of the belt insertion hole are formed into a curved surface of the belt insertion hole by a curved surface curling process after projected toward respective rear sides thereof by a burring process; when the separated base plates abut each other, distal ends of the curved surfaces of the belt insertion holes come into contact with each other, forming a belt contact portion with its cross section of an approximate “C”-shape; a rim of the belt protecting/supporting portion is formed with an outline curved surface of the belt protecting/supporting portion, which is projected and curved toward its rear side by first and second bending processes; when the separated base plates abut each other, distal ends of the outline curved surfaces of the belt protecting/supporting portions come into contact with each other, forming a gripping portion the surface of which is smoothly continued; edges of distal ends of the first and second long peripheral portions and the first and second short peripheral portions are rounded; and a boundary inclined surface is formed between the attachment portion and the belt protecting/supporting portion.

Further, according to a second aspect of the present invention, there is provided a pillar anchor, which a web belt is slidably hung on and supported by, comprising: a pair of separated base plates of steel abutting each other; wherein each of the pair of separated base plates comprises an attachment portion and a belt protecting/supporting portion; the attachment portion is formed with an attachment hole for attaching the pillar anchor to a vehicle body side; a rim of the attachment hole of any one of the pair of separated base plates is formed with an engaging projection projected toward its rear side by a burring process; a rim of the attachment hole of the other of the pair of separated base plates is formed with an engaging depressed portion by a forming process; the engaging projection of the attachment hole of the one of the pair of separated base plates and the engaging depressed portion of the attachment hole of the other of the pair of separated base plates are engaged to each other by a compressing process; the belt protecting/supporting portion is formed with an elongate belt insertion hole for inserting the belt; a first long peripheral portion and first and second short peripheral portions of the belt insertion hole are formed into a curved surface of the belt insertion hole by a curved surface curling process after projected toward respective front sides thereof by an embossing process; when the separated base plates abut each other, distal ends of the curved surfaces of the belt insertion holes come into contact with each other, forming a belt contact portion with its cross section of an approximate “C”-shape; a rim of the belt protecting/supporting portion is formed with an outline curved surface of the belt protecting/supporting portion, which is curved convexly toward its front side by first and second bending processes; when the separated base plates abut each other, distal ends of the outline curved surfaces of the belt protecting/supporting portions come into contact with each other, forming a gripping portion the surface of which is smoothly continued; and edges of distal ends of the first and second long peripheral portions and the first and second short peripheral portions are rounded.

Furthermore, a method for manufacturing the pillar anchor according to a first aspect of the present invention comprises a cutting process for cutting a steel plate into an unwound form of the separated base plates; a first belt insertion hole drawing and attachment hole piercing process for forming a first concave portion by pressing down a portion corresponding to the belt insertion hole of the steel plate and for forming the attachment hole at its corresponding portion on the steel plate; a second belt insertion hole drawing process for forming a second concave portion by further pressing down the first concave portion; a belt insertion hole piercing process for forming the belt insertion hole by piercing the second concave portion; a belt insertion hole burring process for forming a burring projection so that a rim of the belt insertion hole is projected toward its rear side by burring the belt insertion hole; a curved surface forming process for performing surface pressing of a distal end of the burring projection to form a surface pressed projection with an edge of a distal end thereof being rounded; a curved surface curling process for forming the curved surface of the belt insertion hole in an arc shape by pressing the distal end of the surface pressed projection to be curved inward; a notching process for cutting the steel plate along an outline of the attachment portion except a pitch connecting portion and the belt protecting/supporting portion; a first rim bending process for forming a bending projection by bending and projecting a distal end of a rim of the belt protecting/supporting portion to be curved toward its rear side; a second rim bending process for forming the outline curved surface of the belt protecting/supporting portion by bending the rim of the belt protecting/supporting portion including the bending projection to be curved toward its rear side; an attachment hole burring and forming process for forming the engaging projection so that a rim of the attachment hole of the one of the pair of separated base plates is projected toward its rear side by burring the attachment hole, and for forming the engaging depressed portion at a rim of the attachment hole of the other of the pair of separated base plates by forming the rim of the attachment hole; a boundary inclined surface forming process for forming the boundary inclined surface between the attachment portion and the belt protecting/supporting portion; a separating process for cutting and separating the attachment portion from the pitch connecting portion; a separated base plate abutting process for bringing the distal ends of the curved surfaces of the belt insertion holes and the outline curved surfaces of the belt protecting/supporting portions into contact with each other by causing the pair of separated base plates to abut each other; and an attachment hole compressing process for causing the engaging projection of the attachment hole of the one of the pair of separated base plates and the engaging depressed portion of the attachment hole of the other of the pair of separated base plates to be engaged with each other by compressing them to each other.

In addition, a method for manufacturing the pillar anchor according to a second aspect of the present invention comprises a cutting process for cutting a steel plate into an unwound form of the separated base plates; a first long and short peripheral portion embossing and attachment hole piercing process for forming a first convex portion by pressing up portions corresponding to the first long peripheral portion and the first and second short peripheral portions of the belt insertion hole in the steel plate and for forming the attachment hole at its corresponding portion on the steel plate; a second long and short peripheral portion embossing process for forming a second convex portion by further pressing up the first convex portion; a belt insertion hole piercing process for forming the belt insertion hole by piercing the second convex portion; a belt insertion hole burring process for forming a burring edge to direct a rim of the belt insertion hole toward its rear side by burring the belt insertion hole; a curved surface forming process for performing surface pressing of a distal end of the burring edge to form a surface pressed edge with an edge of a distal end thereof being rounded and for performing surface pressing of the distal end of the second long peripheral portion to cause the edge of the distal end of the second long peripheral portion to be rounded; a curved surface curling process for forming the curved surface of the belt insertion hole in an arc shape by pressing the distal end of the surface pressed edge to be curved inward; a notching process for cutting the steel plate along an outline of the attachment portion except a pitch connecting portion and the belt protecting/supporting portion; a first rim bending process for forming a bending edge by bending a distal end of the rim of the belt protecting/supporting portion toward its rear side; a second rim bending process for forming the outline curved surface of the belt protecting/supporting portion by bending the rim of the belt protecting/supporting portion including the bending edge to be curved toward its rear side; an attachment hole burring and forming process for forming the engaging projection so that a rim of the attachment hole of the one of the pair of separated base plates is projected toward its rear side by burring the attachment hole, and for forming the engaging depressed portion at a rim of the attachment hole of the other of the pair of separated base plates by forming the rim of the attachment hole; a separating process for cutting and separating the attachment portion from the pitch connecting portion; a separated base plate abutting process for bringing the distal ends of the curved surfaces of the belt insertion holes and the outline curved surfaces of the belt protecting/supporting portions into contact with each other by causing the pair of separated base plates to abut each other; and an attachment hole compressing process for causing the engaging projection of the attachment hole of the one of the pair of separated base plates and the engaging depressed portion of the attachment hole of the other of the pair of separated base plates to be engaged with each other by compressing them to each other.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a schematic perspective view of a general safety belt apparatus;

FIG. 2a is a perspective view of a conventional pillar anchor;

FIG. 2b is a longitudinal section view of the conventional pillar anchor shown in FIG. 2a;

FIG. 3 is a perspective view of a pillar anchor according to a first embodiment of the present invention;

FIG. 4a is a front view of the pillar anchor shown in FIG. 3;

FIG. 4b is a longitudinal section view of the pillar anchor shown in FIG. 4a;

FIGS. 5a and 5b are front and rear views of a pair of separated base plates of the pillar anchor shown in FIG. 3;

FIG. 6 is a front view showing a series of manufacturing processes of the pair of separated base plates of the pillar anchor according to the first embodiment of the present invention;

FIG. 7 is a view explaining a first drawing process of the pair of separated base plates of the pillar anchor according to the first embodiment of the present invention;

FIG. 8 is a view explaining a second drawing process of the pair of separated base plates of the pillar anchor according to the first embodiment of the present invention;

FIG. 9 is a view explaining a piercing process of a belt insertion hole of the pair of separated base plates of the pillar anchor according to the first embodiment of the present invention;

FIG. 10 is a view explaining a burring process of the belt insertion hole of the pair of separated base plates of the pillar anchor according to the first embodiment of the present invention;

FIG. 11 is a view explaining a curved surface forming process of the pair of separated base plates of the pillar anchor according to the first embodiment of the present invention;

FIG. 12 is a view explaining a curved surface curling process of the pair of separated base plates of the pillar anchor according to the first embodiment of the present invention;

FIG. 13 is a view explaining a notching process of the pair of separated base plates of the pillar anchor according to the first embodiment of the present invention;

FIG. 14 is a view explaining a first bending process of an edge of a belt protecting/supporting portion of the pair of separated base plates of the pillar anchor according to the first embodiment of the present invention;

FIG. 15 is a view explaining a second bending process of the edge of the belt protecting/supporting portion of the pair of separated base plates of the pillar anchor according to the first embodiment of the present invention;

FIG. 16 is a view explaining a burring and forming process of an attachment hole of the pair of separated base plates of the pillar anchor according to the first embodiment of the present invention;

FIG. 17 is a view explaining a forming process of boundary inclined surface of the pair of separated base plates of the pillar anchor according to the first embodiment of the present invention;

FIG. 18 is a view explaining an abutting process of the pair of separated base plates of the pillar anchor according to the first embodiment of the present invention;

FIG. 19 is a view explaining a compressing process of the attachment hole of the pair of separated base plates of the pillar anchor according to the first embodiment of the present invention;

FIG. 20 is a view of spot-welded portions formed on an attachment portion of the pair of separated base plates of the pillar anchor according to the first embodiment of the present invention;

FIG. 21 is a view of the pair of separated base plates of the pillar anchor according to the first embodiment of the present invention which are engaged to each other by edge-welding;

FIG. 22 is a view of the pair of separated base plates of the pillar anchor according to the first embodiment of the present invention which are engaged to each other by means of a hook and a catching hole;

FIG. 23 is a perspective view of a modified example of the pillar anchor according to the first embodiment of the present invention;

FIG. 24 is a longitudinal section view of the pillar anchor shown in FIG. 23;

FIGS. 25a and 25b are front and rear perspective views of a pair of separated base plates of the pillar anchor shown in FIG. 23;

FIG. 26 is a perspective view of another modified example of the pillar anchor according to the first embodiment of the present invention;

FIG. 27 is a longitudinal section view of the pillar anchor shown in FIG. 26;

FIGS. 28a and 28b are front and rear perspective views of a pair of separated base plates of the pillar anchor shown in FIG. 26;

FIG. 29 is a perspective view of a further modified example of the pillar anchor according to the first embodiment of the present invention;

FIG. 30 is a longitudinal section view of the pillar anchor shown in FIG. 29;

FIGS. 31a and 31b are front and rear perspective views of a pair of separated base plates of the pillar anchor shown in FIG. 29;

FIG. 32 is a perspective view of a pillar anchor according to a second embodiment of the present invention;

FIG. 33 is a longitudinal section view of the pillar anchor shown in FIG. 32;

FIG. 34 is a view explaining a first embossing process of a pair of separated base plates of the pillar anchor according to the second embodiment of the present invention;

FIG. 35 is a view explaining a second embossing process of the pair of separated base plates of the pillar anchor according to the second embodiment of the present invention;

FIG. 36 is a view explaining a piercing process of a belt insertion hole of the pair of separated base plates of the pillar anchor according to the second embodiment of the present invention;

FIG. 37 is a view explaining a burring process of the belt insertion hole of the pair of separated base plates of the pillar anchor according to the second embodiment of the present invention;

FIG. 38 is a view explaining a curved surface forming process of the pair of separated base plates of the pillar anchor according to the second embodiment of the present invention;

FIG. 39 is a view explaining a curved surface curling process of the pair of separated base plates of the pillar anchor according to the second embodiment of the present invention;

FIG. 40 is a view explaining a notching process of the pair of separated base plates of the pillar anchor according to the second embodiment of the present invention;

FIG. 41 is a view explaining a first bending process of an edge of a belt protecting/supporting portion of the pair of separated base plates of the pillar anchor according to the second embodiment of the present invention;

FIG. 42 is a view explaining a second bending process of the edge of the belt protecting/supporting portion of the pair of separated base plates of the pillar anchor according to the second embodiment of the present invention;

FIG. 43 is a view explaining a burring and forming process of an attachment hole of the pair of separated base plates of the pillar anchor according to the second embodiment of the present invention;

FIG. 44 is a view explaining a forming process of boundary bent surface of the pair of separated base plates of the pillar anchor according to the second embodiment of the present invention;

FIG. 45 is a view explaining an abutting process of the pair of separated base plates of the pillar anchor according to the second embodiment of the present invention; and

FIG. 46 is a view explaining a compressing process of the attachment hole of the pair of separated base plates of the pillar anchor according to the second embodiment of the present invention.

### DETAILED DESCRIPTION OF THE PREFERRED EMBODIMENT

Hereinafter, preferred embodiments of the present invention will be described in detail with reference to the accompanying drawings.

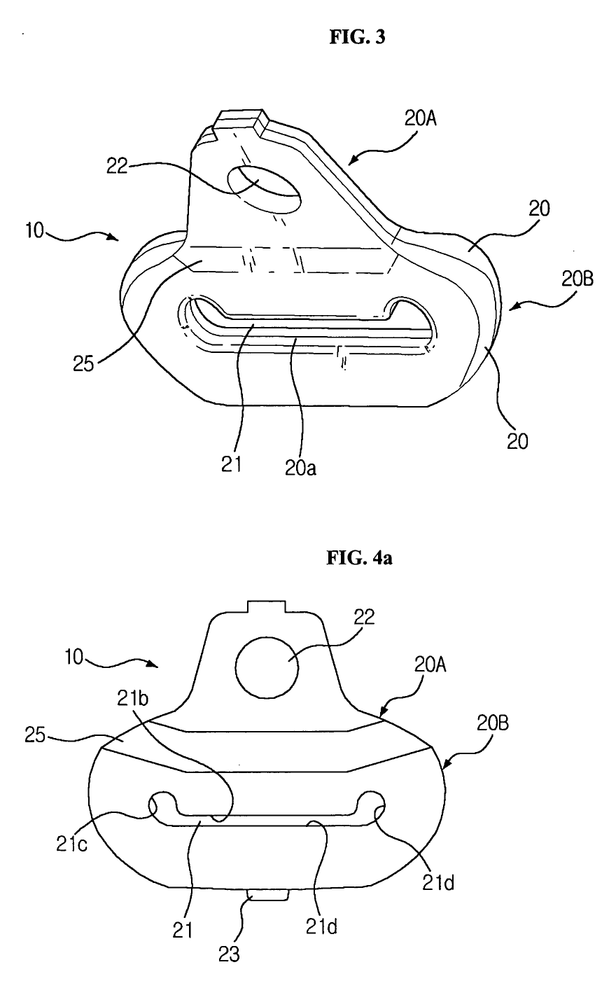

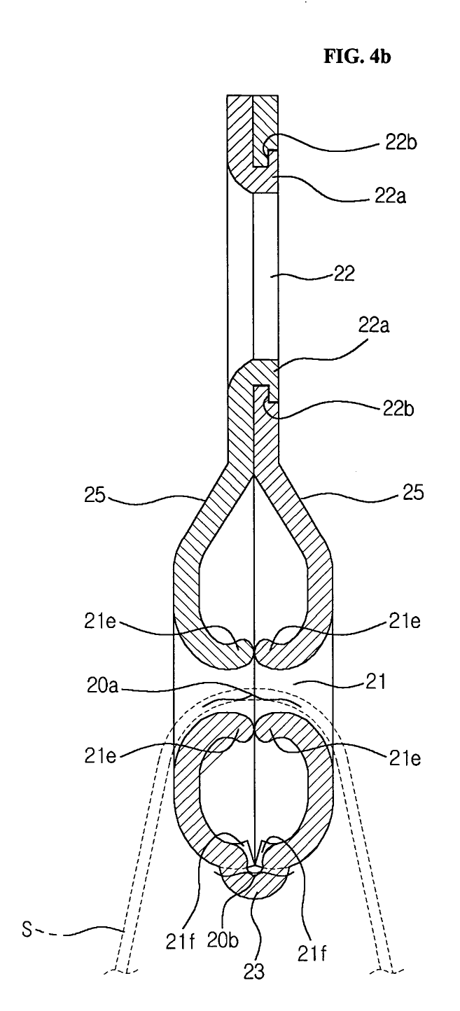

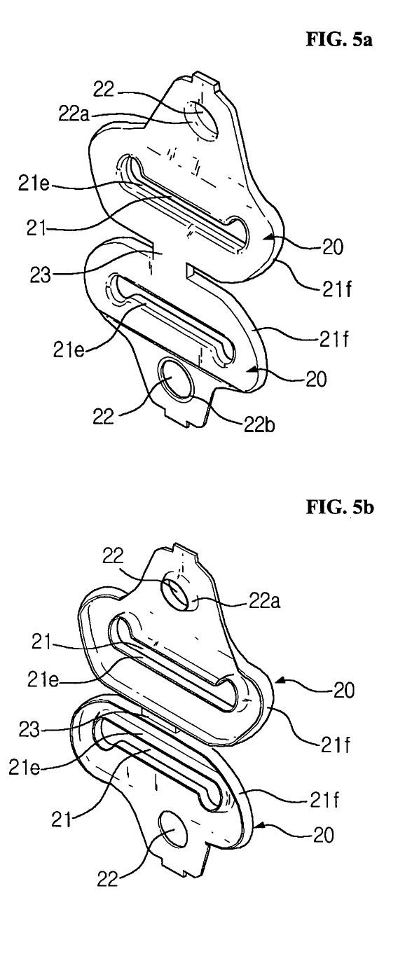

As shown in FIGS. 3 to 5b, a pillar anchor 10 illustrated as a first embodiment of the present invention, which a web belt S is slidably hung on and supported, comprises a pair of separated base plates 20 and 20 of steel, which abut each other, and each of which has a belt insertion hole 21 for inserting the web belt S therethrough. The pair of separated base plates 20 and 20 connected to each other by means of a connecting piece 23 abut each other by a bending process, and then, are integrated into a finished product by burring and compressing them. When the pair of separated base plates 20 and 20 abut each other, an inner peripheral surface of the belt insertion holes 21 and 21, which includes a belt contact portion 20a over which the web belt S is folded, is formed in a curved shape, in order for the belt contact portion 20a to have a predetermined thickness and for the web belt S to be smoothly curved. In addition, an outer rim of a belt protecting/supporting portion of each of the separated base plates 20 and 20 is formed in a curved shape in order to make a portion which a user touches smooth when the pair of separated base plates 20 and 20 abut each other.

Each of the pair of separated base plates 20 and 20 connected to each other by means of the connecting piece 23, is formed by piercing a steel plate with a predetermined thickness and by a press process, and comprises an attachment portion 20A and a belt protecting/supporting portion 20B, as shown in FIG. 3. Herein, the connecting piece 23 is formed at intermediate portions of long peripheral portion sides of the outer rims of the belt protecting/supporting portions 20B and 20B of the respective separated base plates 20 and 20.

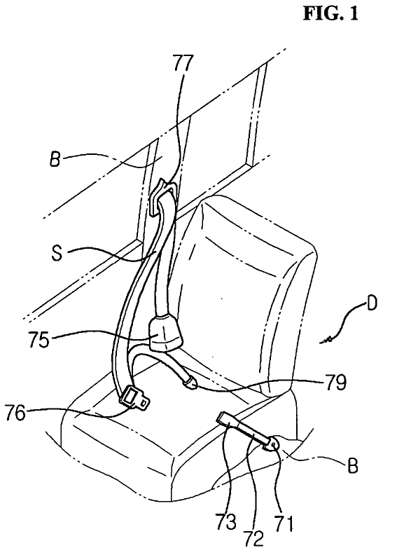

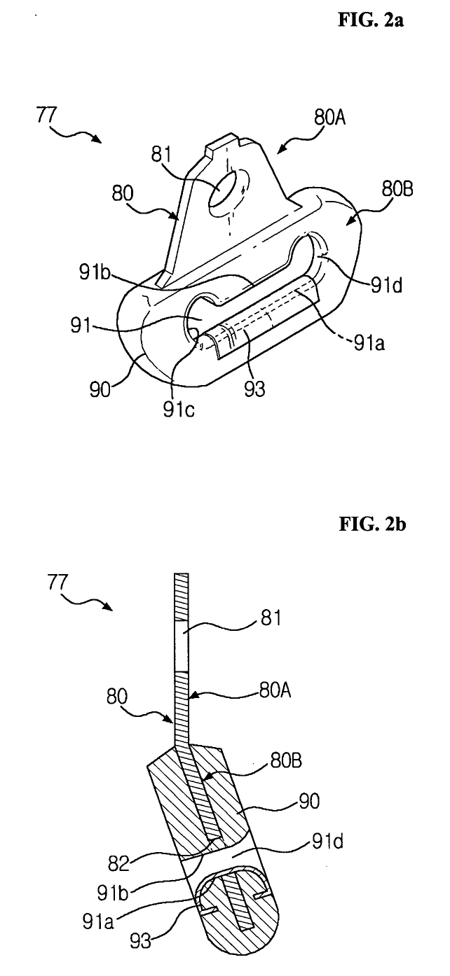

The attachment portion 20A is formed with an attachment hole 22 for attaching the pillar anchor 10 to a lateral surface of the vehicle body B (see FIG. 1). A rim of the attachment hole 22 of any one of the pair of separated base plates 20 and 20 is formed with an engaging projection 22a, which is projected toward its rear side by a burring process. Further, a rim of the attachment hole 22 of the other of the pair of separated base plates 20 and 20 is formed with an engaging depressed portion 22b formed by a forming process.

The engaging projection 22a of the attachment hole 22 of the one of the pair of separated base plates 20 and 20 and the engaging depressed portion 22b of the attachment hole 22 of the other of the pair of separated base plates 20 and 20 are engaged by a compressing process.

The belt protecting/supporting portion 20B is formed with the belt insertion hole 21 of an elongated hole shape for inserting the web belt S therethrough. The belt insertion hole 21 comprises straight first and second long peripheral portions 21a and 21b opposite to each other and arc-shaped first and second short peripheral portions 21c and 21d formed continuously from ends of the long peripheral portions 21a and 21b, as shown in FIG. 3. Then, the first and second long peripheral portions 21a and 21b and the first and second short peripheral portions 21c and 21d of the belt insertion hole 21 are projected toward the respective rear sides thereof by a burring process. The portion projected by the burring process is formed into a curved surface 21e of the belt insertion hole by a curved surface curling process. In addition, edges of distal ends of the first and second long peripheral portions 21a and 21b and the first and second short peripheral portions 21c and 21d are subjected to a rounding process.

Therefore, when the separated base plates 20 and 20 abut each other, distal ends of the curved surfaces 21e and 21e of the belt insertion holes come into contact with each other, so that a cross section of the belt contact portion 20a is in the form of a “C”-shape. That is, the belt contact portion 20a over which the belt S is folded is formed in a shape curved along a direction in which the belt S is folded.

Further, the outer rim of the belt protecting/supporting portion 20B is formed with an outline curved surface 21f of the belt protecting/supporting portion, which is projected and curved toward its rear side by first and second bending processes. When the separated base plates 20 and 20 abut each other, distal ends of the outline curved surfaces 21f and 21f of the belt protecting/supporting portions come into contact with each other, so that a gripping portion 20b is formed. That is, the gripping portion 20b gripped by the user's hand has a curved surface formed to be smoothly continued.

A boundary inclined surface 25 is formed between the attachment portion 20A and the belt protecting/supporting portion 20B. As described above, in the first embodiment, although the curved surfaces 21e and 21e of the belt insertion holes and the outline curved surfaces 21f and 21f of the belt protecting/supporting portions are projected toward the respective rear sides, when the pair of separated base plates 20 and 20 abut each other, surfaces of the respective attachment portions 20A and 20A come into contact with each other by the boundary inclined surfaces 25 and 25. Thus, the engaging projection 22a of the attachment hole 22 of the one of the pair of separated base plates 20 and 20 and the engaging depressed portion 22b of the attachment hole 22 of the other of the pair of separated base plates 20 and 20 may be engaged by the compressing process.

Here, projected heights of the curved surfaces 21e and 21e of the belt insertion holes of the respective separated base plates 20 and 20 are the same, and projected heights of the outline curved surfaces 21f and 21f of the belt protecting/supporting portions of the respective separated base plates 20 and 20 are also the same. Therefore, the distal ends of the curved surface 21e of the belt insertion hole and the outline curved surface 21f of the belt protecting/supporting portion of any one of the pair of separated base plates 20 and 20 and the distal ends of the curved surface 21e of the belt insertion hole and the outline curved surface 21f of the belt protecting/supporting portion of the other of the pair of separated base plates 20 and 20 meet at a thicknesswise center line of the pillar anchor 10.

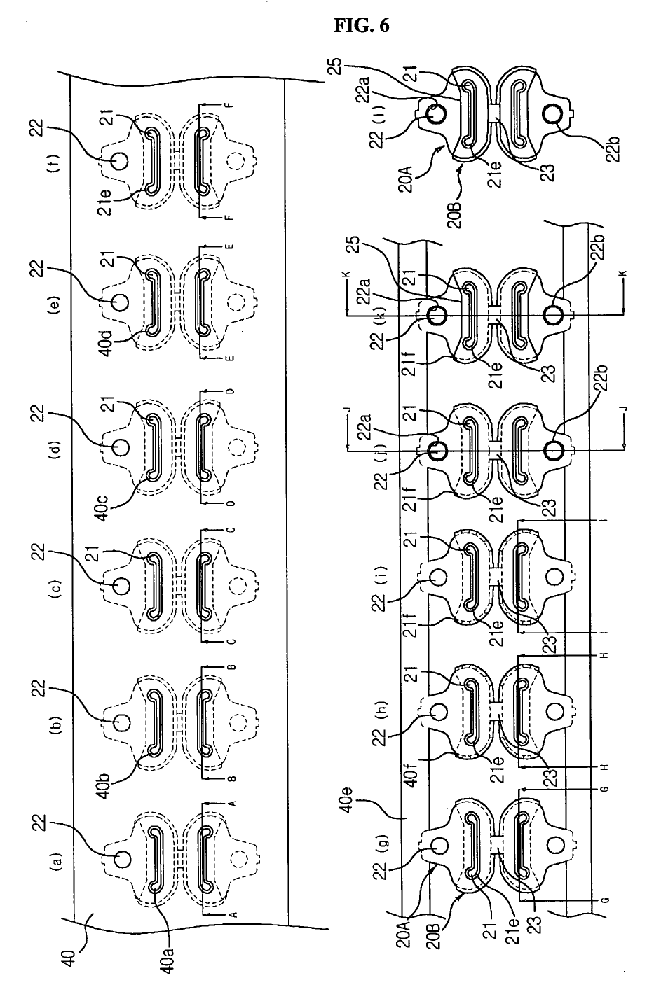

Next, a method for manufacturing the pillar anchor 10 of the present embodiment will be described with reference to FIGS. 6 to 19.

The pillar anchor 10, which the web belt S is slidably hung on and supported by, is manufactured by forming the pair of separated base plates 20 and 20 of steel, each of which has the belt insertion hole 21 for inserting the web belt S, to be connected to each other by means of the connecting piece 23, and then, bending the connecting piece 23 in order for the separated base plates 20 and 20 to abut each other.

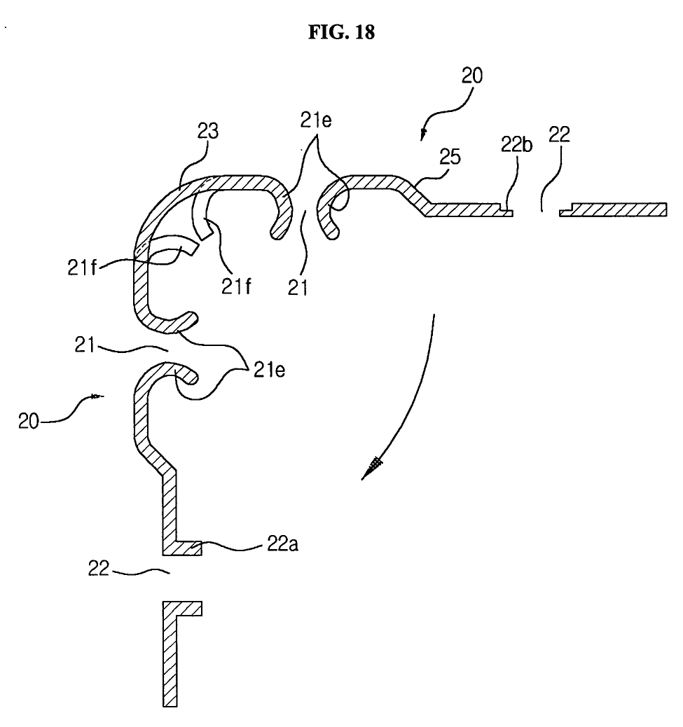

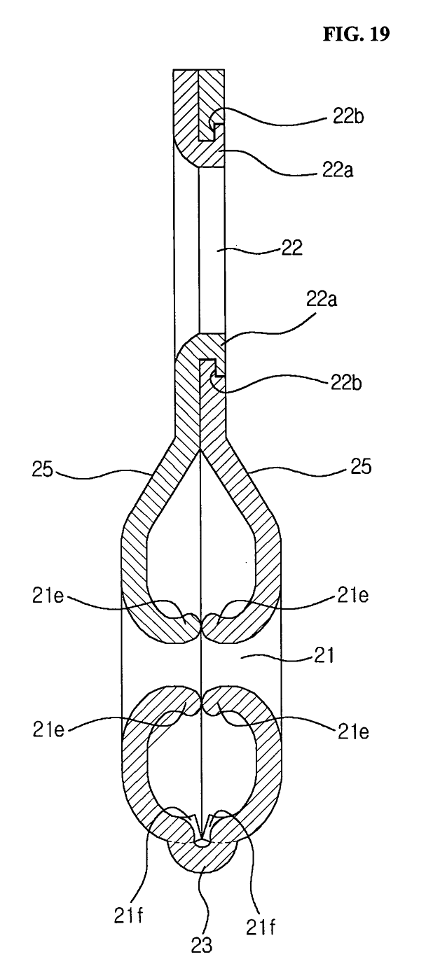

Modified into a flat plate and then conveyed to a set of press machines which perform respective processes shown in FIGS. 6 to 17 in automatically sequence, a plate wound in a coil shape, which is a material of the separated base plates 20 and 20 with a predetermined thickness, is manufactured by means of the press machines sequentially. In the meantime, an abutting process of the separated base plates and a compressing process of the attachment holes illustrated in FIGS. 18 and 19 are performed by a separate press machine.

First, as a preparatory stage, a steel plate 40 is cut into an unwound form of the separated base plates 20 and 20.

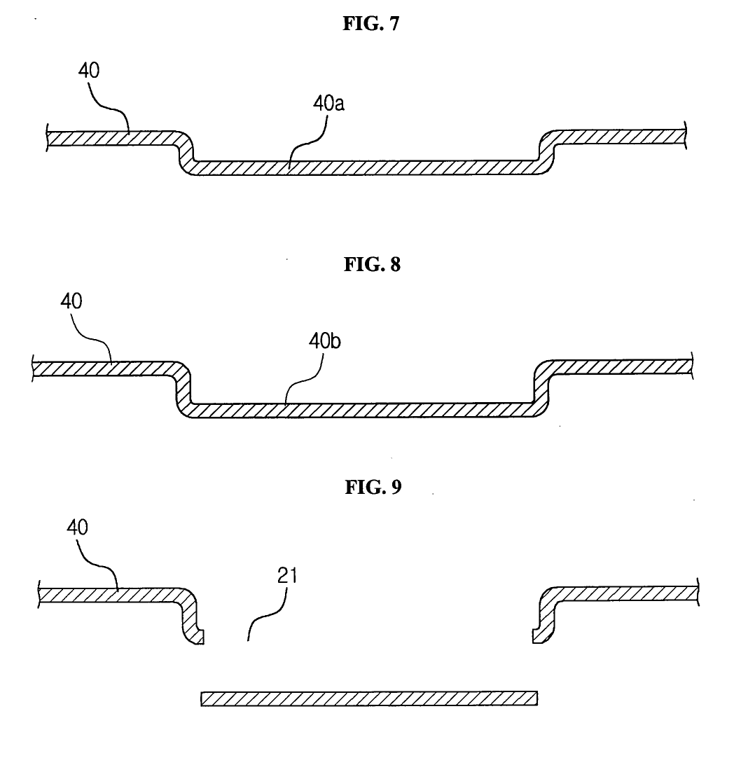

Then, in a first drawing process of the belt insertion hole and a piercing process of the attachment hole as shown in FIG. 7, a first concave portion 40a is formed by pressing down a portion corresponding to the belt insertion hole of the steel plate 40, and at the same time, the attachment hole 22 is formed at its corresponding portion on the steel plate 40.

Next, in the second drawing process as shown in FIGS. 6(b) and 8, a second concave portion 40b is formed by further pressing down the first concave portion 40a. Since a pressure load applied to the steel plate 40 can be as small as possible by dividing a drawing process into two processes, i.e., the first and second drawing processes as described above, the steel plate 40 is prevented from cracking, and at the same time, a mold is also prevented from damage, improving durability of the mold.

Then, in a piercing process of the belt insertion hole as shown in FIGS. 6(c) and 9, the belt insertion hole 21 is formed by piercing the second concave portion 40b.

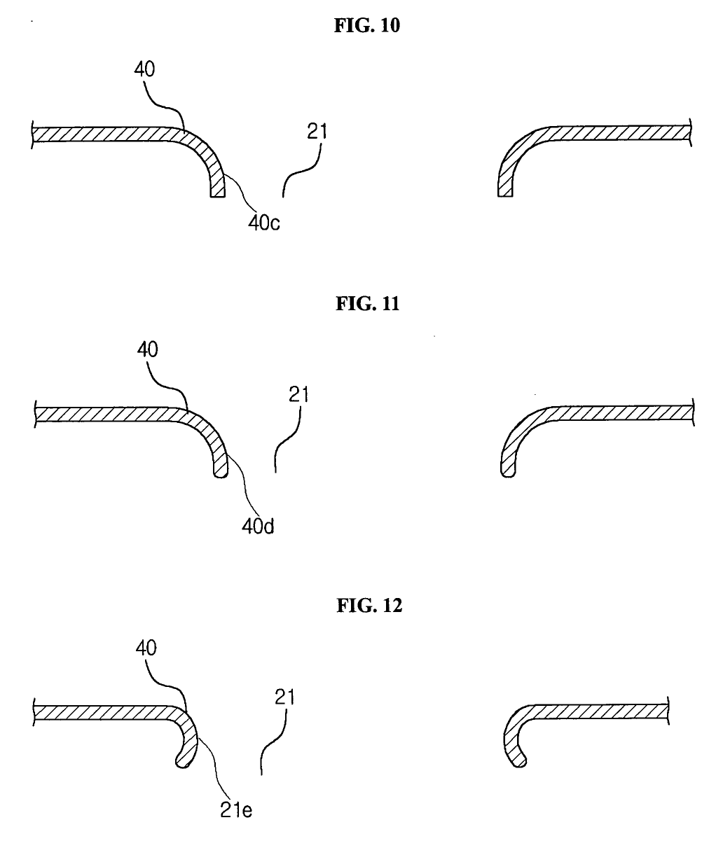

Then, in a burring process of the belt insertion hole as shown in FIGS. 6(d) and 10, a burring projection 40c is formed so that a rim of the belt insertion hole 21 is projected toward its rear side by burring the belt insertion hole 21.

Next, in a curved surface forming process as shown in FIGS. 6(e) and 11, a surface pressed projection 40d, an edge of a distal end of which is rounded, is formed by performing the surface pressing of a distal end of the burring projection 40c.

Next, in a curved surface curling process as shown in FIGS. 6(f) and 12, the curved surface 21e of the belt insertion hole is formed in an arc shape by pressing the distal end of the surface pressed projection 40d to be curved inward.

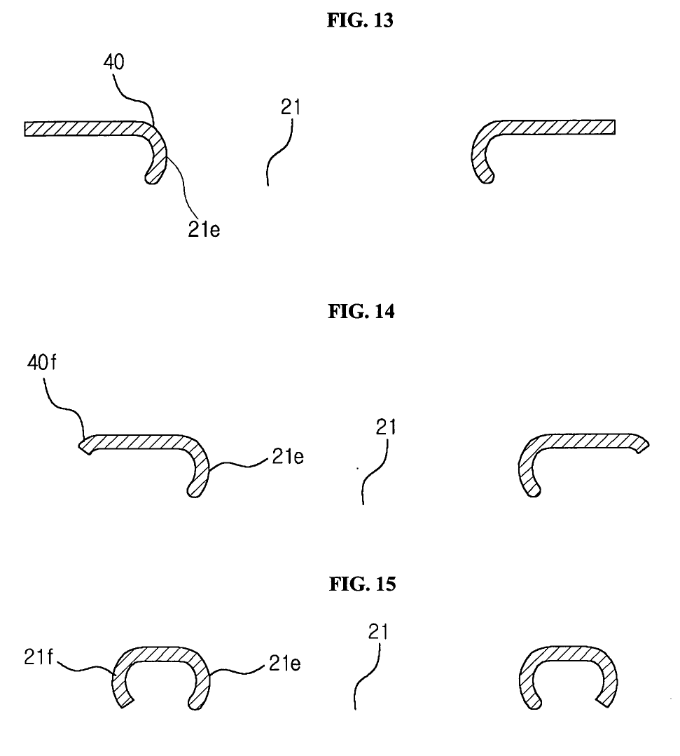

Then, in a notching process as shown in FIGS. 6(g) and 13, the pair of separated base plates 20 and 20 are formed by cutting the steel plate 40 along an outline of the attachment portions 20A and 20A except a pitch connecting portion 40e and the belt protecting/supporting portions 20B and 20B. At this time, the connecting piece 23 for connecting the intermediate portions of long peripheral portion sides of the outer rims of the belt protecting/supporting portions 20B and 20B is formed.

Next, in a first bending process of the rim of the belt protecting/supporting portion as shown in FIGS. 6(h) and 14, a bending projection 40f is formed by bending and projecting a distal end of the rim of the belt protecting/supporting portion 20B to be curved toward its rear side.

Next, in a second bending process of the rim of the belt protecting/supporting portion as shown in FIGS. 6(i) and 15, the outline curved surface 21f of the belt protecting/supporting portion is formed by bending the rim of the belt protecting/supporting portion 20B including the bending projection 40f to be curved toward its rear side.

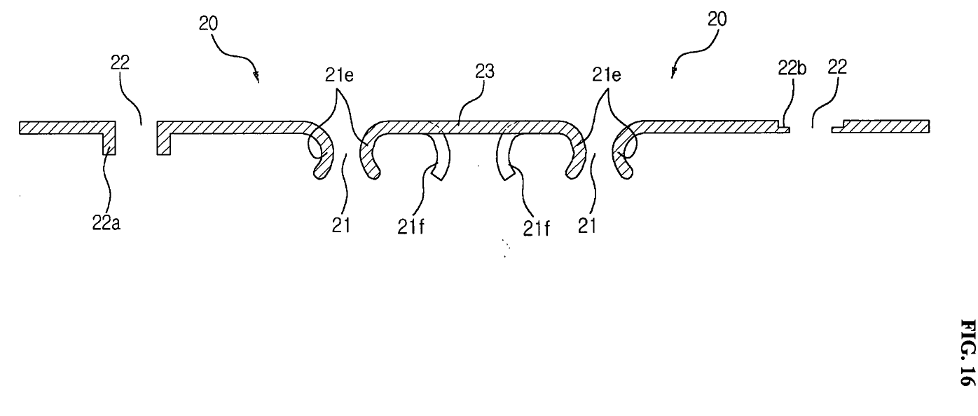

Next, in a burring and forming process of the attachment hole as shown in FIGS. 6 (j) and 16, the engaging projection 22a is formed so that a rim of the attachment hole 22 of the one of the pair of separated base plates 20 and 20 is projected toward its rear side by burring the attachment hole 22, and at the same time, the engaging depressed portion 22b is formed at a rim of the attachment hole 22 of the other of the pair of separated base plates 20 and 20 by forming the rim of the attachment hole 22.

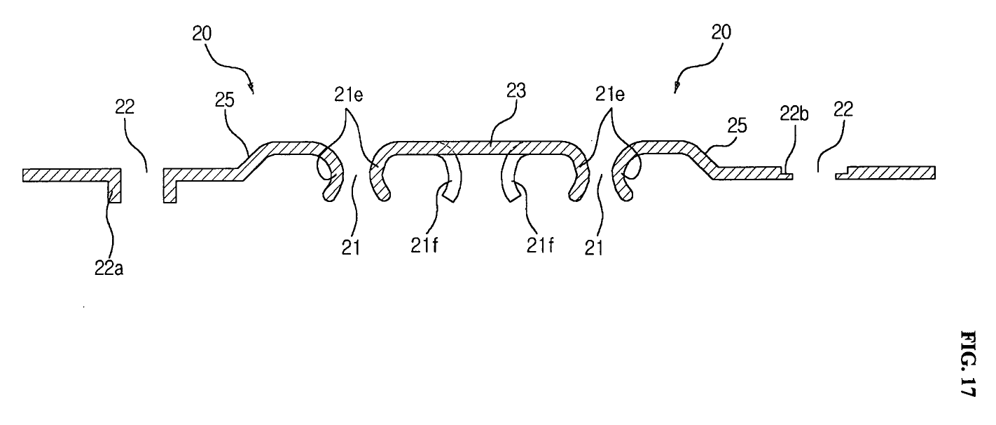

Then, in a forming process of the boundary inclined surface as shown in FIGS. 6 (k) and 17, the boundary inclined surface 25 is formed between the attachment portion 20A and the belt protecting/supporting portion 20B.

Then, in a separating process as shown in FIG. 6(l), the attachment portion 20A is cut and separated from the pitch connecting portion 40e.

Then, in an abutting process of the separated base plates as shown in FIG. 18, the pair of separated base plates 20 and 20 abut each other so that the distal ends of the curved surfaces 21e and 21e of the belt insertion holes and the outline curved surfaces 21f and 21f of the belt protecting/supporting portions are brought into contact with each other by bending the connecting piece 23.

Next, in the compressing process of the attachment holes as shown in FIG. 19, the engaging projection 22a of the attachment hole 22 of the one of the pair of separated base plates 20 and 20 and the engaging depressed portion 22b of the attachment hole 22 of the other of the pair of separated base plates 20 and 20 are engaged with each other by compressing them to each other.

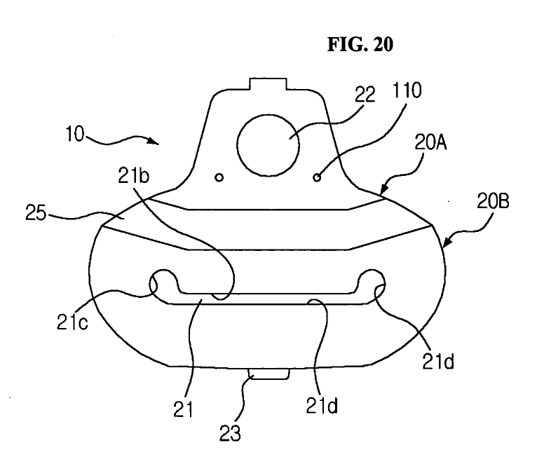

In addition, after the engaging projection 22a and the engaging depressed portion 22b are engaged with each other by the compression, in order to reinforce an engaging force between the pair of separated base plates 20 and 20, spot-welding may be performed in the neighborhood of the attachment holes 22 and 22 in the attachment portions 20A and 20A of the pair of separated base plates 20 and 20. FIG. 20 shows spot-welded portions 110.

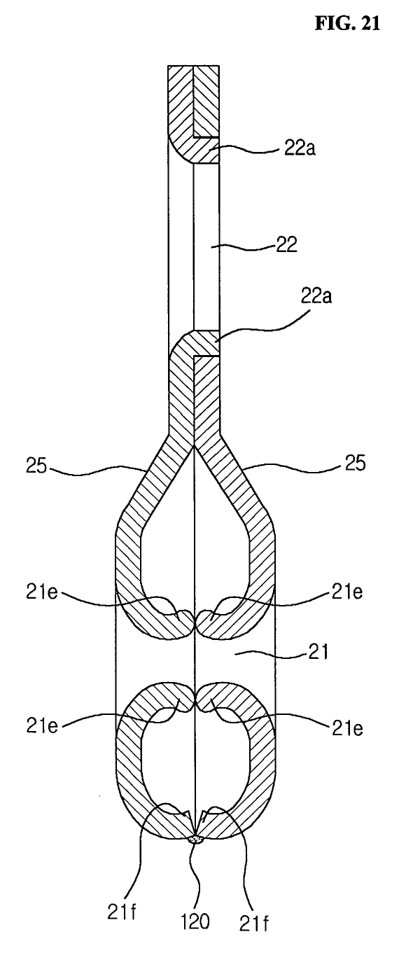

Up to now, the pair of separated base plates 20 and 20 abut each other by bending the connecting piece 23 after manufacturing the pair of separated base plates 20 and 20 to be connected to each other by the connecting piece 23. However, as shown in FIG. 21, the pair of separated base plates 20 and 20 may be engaged to each other by an edge-welded portion 120, which is formed by edge-welding the distal ends, at which the outline curved surfaces 21f and 21f of the belt protecting/supporting portions come into contact with each other, after manufacturing the pair of separated base plates 20 and 20 not to be connected to each other at first. In such a case, since the distal ends, in which the outline curved surfaces 21f and 21f of the belt protecting/supporting portions come into contact with each other, are edge-welded as a whole, it does not matter from a point of an engaging structure if there is no structure of the engaging projection 22a and the engaging depressed portion 22b of the attachment holes 22 and 22 of the respective separated base plates 20 and 20 which are engaged by the compressing process.

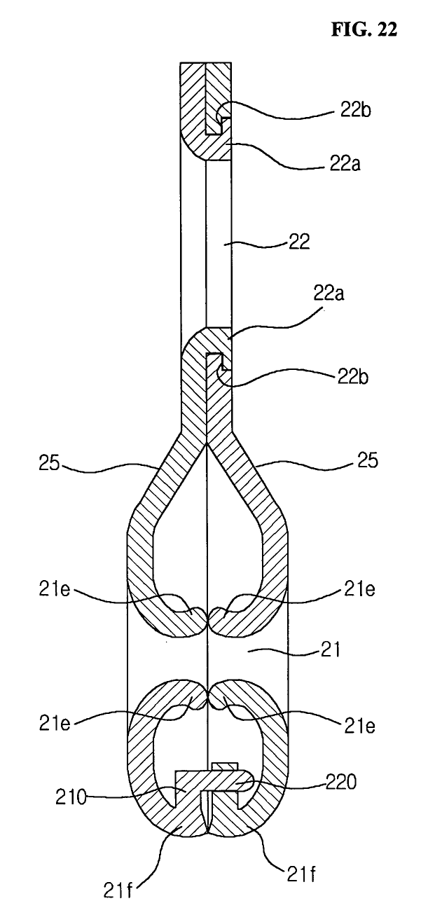

In addition, as shown in FIG. 22, in case that the pair of separated base plates 20 and 20 are manufactured not to be connected to each other at first, instead of the connecting piece 23, the pair of separated base plates 20 and 20 are formed with a hook 210 and a catching hole 220, respectively, so that the pair of separated base plates 20 and 20 may be engaged to each other by fixing the hook 210 into the catching hole 220.

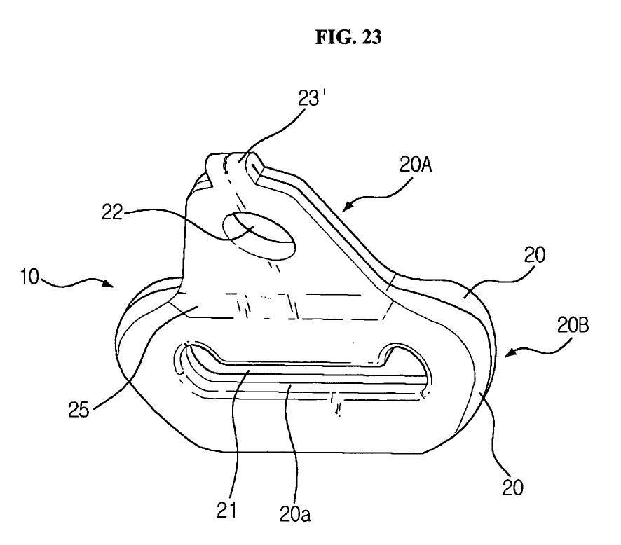

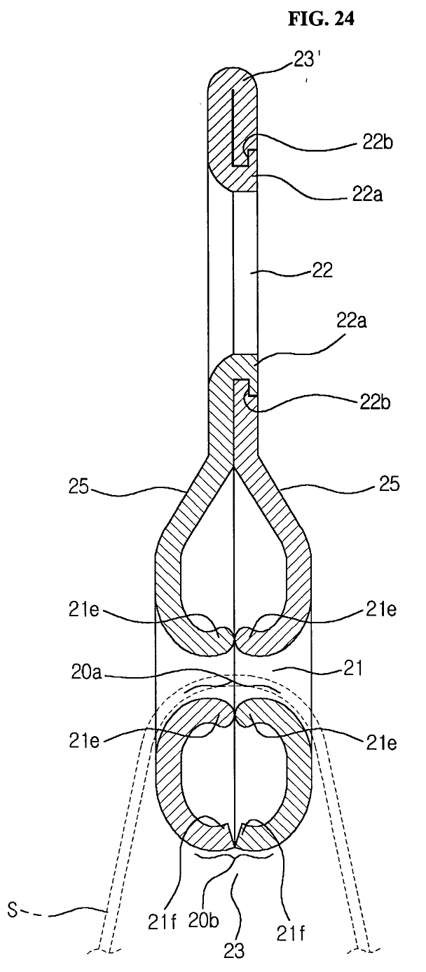

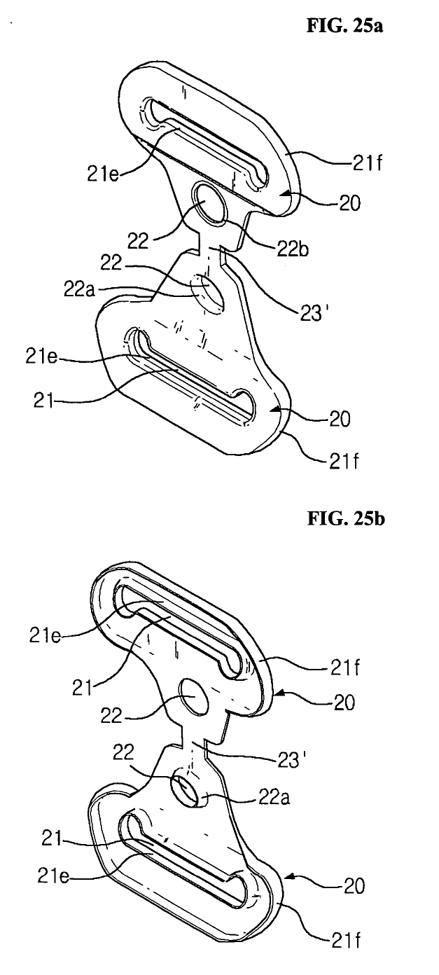

In addition, although the connecting piece 23 is formed at the intermediate portions of the long peripheral portion sides of the outer rims of the belt protecting/supporting portions 20B and 20B of the respective separated base plates 20 and 20 in the previous example, a connecting piece 23′ as another connecting piece may be formed at upper ends of the attachment holes 22 and 22 of the attachment portions 20A and 20A of the respective separated base plates 20 and 20, as shown in FIGS. 23 to 25. In such a case, in the notching process of the method for manufacturing the pillar anchor, the outlines of the attachment portions 20A and 20A are cut so that the upper ends of the attachment holes 22 and 22 of the attachment portions 20A and 20A of the pair of separated base plates 20 and 20 are connected to each other by the connecting piece 23′. Also, in the abutting process of the separated base plates, the pair of separated base plates 20 and 20 abut and are engaged to each other by bending the connecting piece 23′.

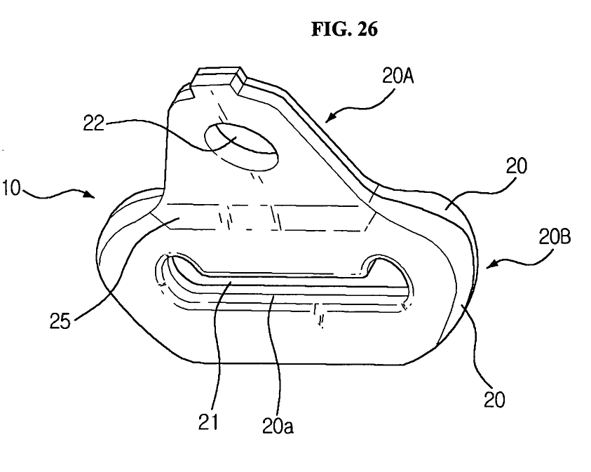

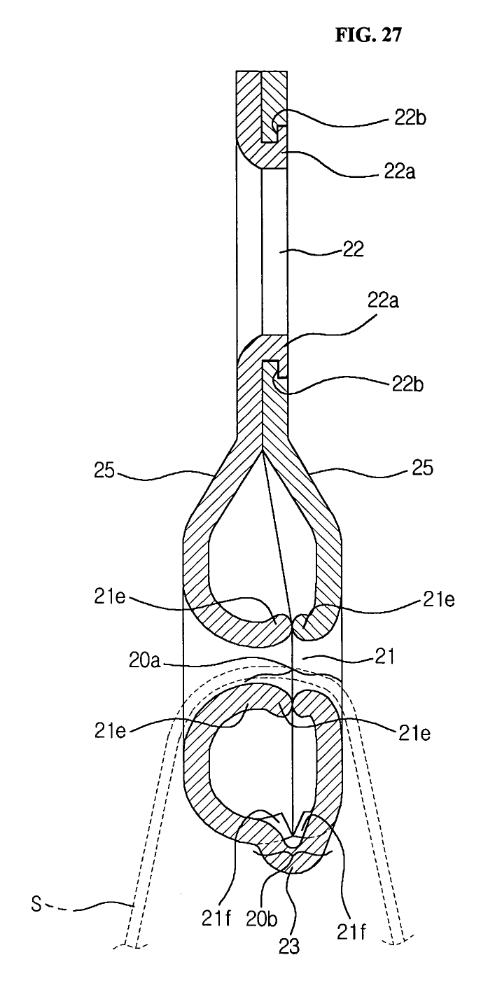

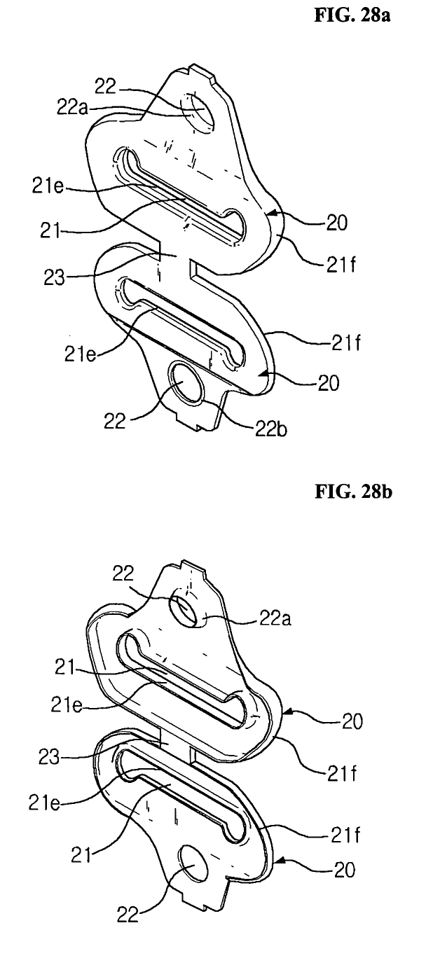

Furthermore, in the previous example, the curved surfaces 21e and 20e of the belt insertion holes of the pair of separated base plates 20 and 20 are formed so that the projected heights thereof are the same, and the outline curved surfaces 21f and 21f of the belt protecting/supporting portions of the pair of separated base plates 20 and 20 are also formed so that the projected heights thereof are the same. However, as shown in FIGS. 26 to 28, the curved surface 21e of the belt insertion hole and the outline curved surface 21f of the belt protecting/supporting portion of any one of the pair of separated base plates 20 and 20 may be formed so that the projected heights thereof go across the thicknesswise center line of the pillar anchor 10, while the curved surface 21e of the belt insertion hole and the outline curved surface 21f of the belt protecting/supporting portion of the other of the pair of separated base plates 20 and 20 may be formed so that the projected heights thereof do not go up to the thicknesswise center line of the pillar anchor 10. In such a case, since an apex of the belt S which is subjected to a maximum force is hung over the curved surface 21e of the belt insertion hole of the one of the pair of separated base plates 20 and 20, the belt S can be more stably maintained between the distal ends of the curved surfaces 21e and 21e of the belt insertion holes of the pair of separated base plates 20 and 20.

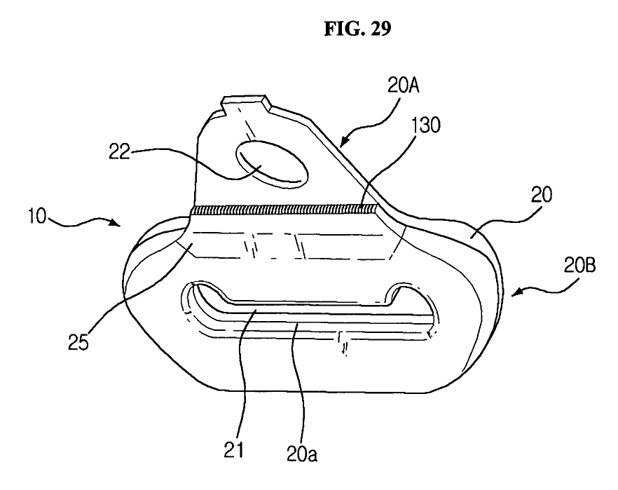

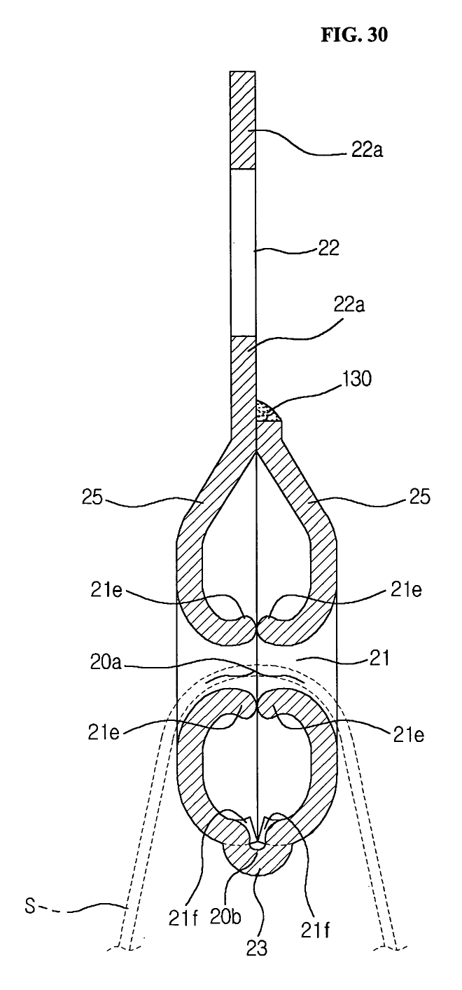

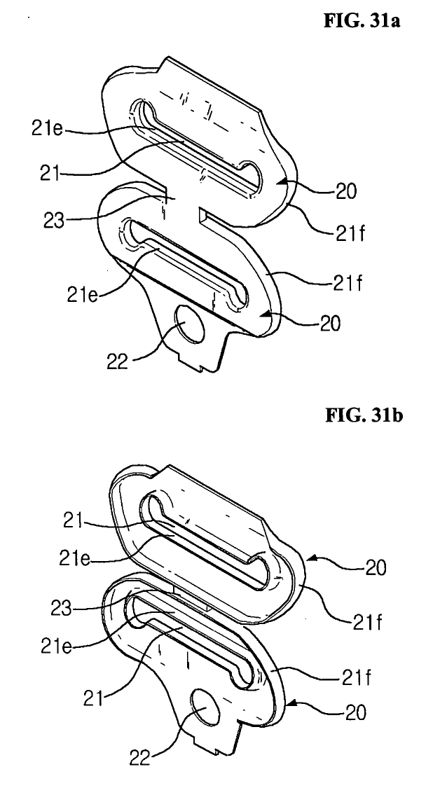

In addition, although the pair of separated base plates 20 and 20 are generally formed in the same shape, the attachment portion 20A of any one of the pair of separated base plates 20 and 20 may be omitted, as shown in FIGS. 29 to 31. Here, a portion, in which the belt protecting/supporting portion 20B of the one of the pair of separated base plates 20 and 20 and the attachment portion 20A of the other of the pair of separated base plates 20 and 20 meet each other, may be line-welded, which may result in a line-welded portion 130. In such a case, since the attachment portion 20A of the one of the pair of separated base plates 20 and 20 is not necessary, material may be saved. Further, as shown in FIG. 22, the pair of separated base plates 20 and 20 may be engaged by fixing the hook 210 into the catching hole 220 after forming the hook 210 and the catching hole 220 at respective distal ends of the portions, in which the belt protecting/supporting portion 20B of the one of the pair of separated base plates 20 and 20 and the attachment portion 20A of the other of the pair of separated base plates 20 and 20 meet.

Up to the present, the pillar anchor, in which the curved surfaces of the belt insertion holes and the outline curved surfaces of the belt protecting/supporting portions are formed through the drawing processes, is illustrated as the first embodiment. However, hereinafter, a pillar anchor, in which curved surfaces of insertion holes and outline curved surfaces of belt protecting/supporting portions are formed through embossing processes, will be described as a second embodiment. In the second embodiment, the same constitution as in the first embodiment will be omitted.

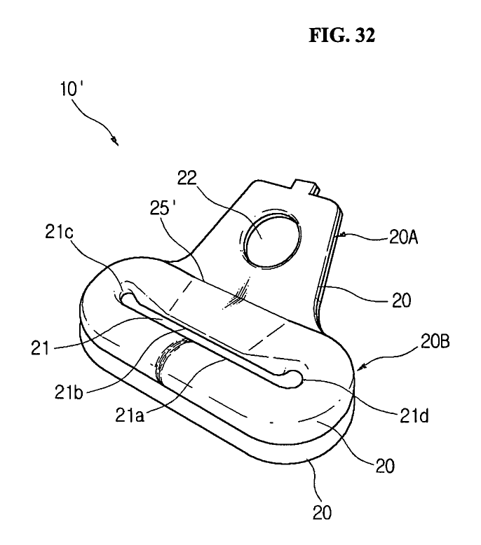

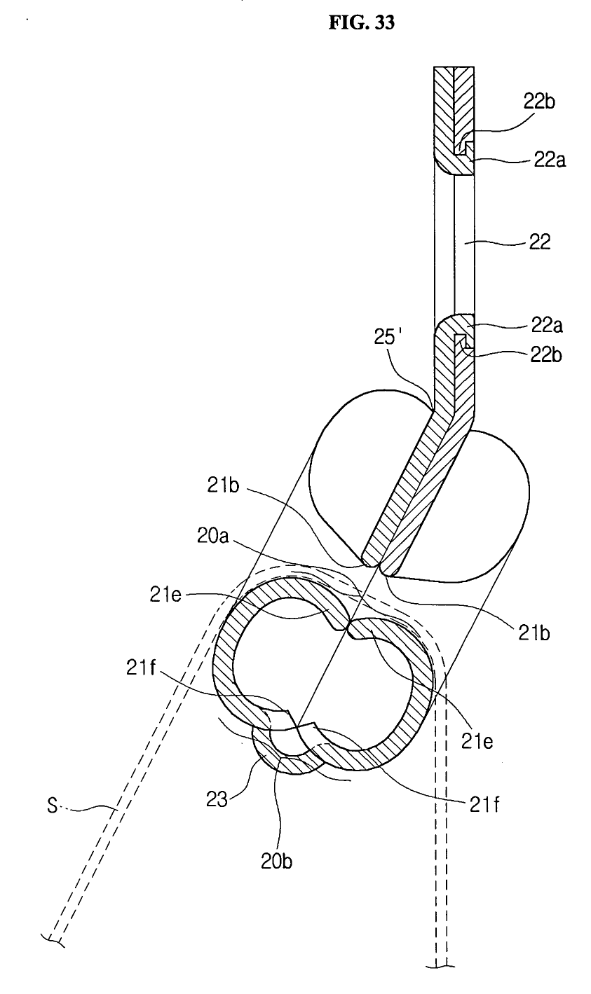

As shown in FIGS. 32 and 33, in the pillar anchor 10′ illustrated as the second embodiment of the present invention, a first long peripheral portion 21a and first and second short peripheral portions 21c and 21d of each belt insertion hole 21 are convexly projected toward front sides thereof by the embossing processes. The projection subjected to the embossing process forms a curved surface 21e of the belt insertion hole by a curved surface curling process. In addition, edges of distal ends of the first and second long peripheral portions 21a and 21b and the first and second short peripheral portions 21c and 21d are subjected to a rounding process. The second long peripheral portion 21b remains flat.

Therefore, when the separated base plates 20 and 20 abut each other, distal ends of the curved surfaces 21e and 21e of the belt insertion holes come into contact with each other, so that a cross section of the belt contact portion 20a is in the form of a “C”-shape. That is, the belt contact portion 20a over which the web belt S is folded is formed in a shape curved along a direction in which the web belt S is folded. If the second long peripheral portions 21b and 21b of the respective separated base plates 20 and 20 abut each other, the distal ends the edges of which are rounded overlap with each other in plane.

Further, the outer rim of the belt protecting/supporting portion 20B is formed with an outline curved surface 21f of the belt protecting/supporting portion, which is curved convexly toward its front side by first and second bending processes. When the separated base plates 20 and 20 abut each other, distal ends of the outline curved surfaces 21f and 21f of the belt protecting/supporting portions come into contact with each other, so that a gripping portion 20b is formed. That is, the gripping portion 20b gripped by the user's hand has a curved surface formed to be smoothly continued.

In the second embodiment, since the curved surfaces 21e and 21e of the belt insertion holes and the outline curved surfaces 21f and 21f of the belt protecting/supporting portions are formed convexly toward respective front sides thereof, the distal ends thereof are coplanar with the attachment portions 20A and 20A, respectively.

As described above, in the second embodiment, since the curved surfaces 21e and 21e of the belt insertion holes and the outline curved surfaces 21f and 21f of the belt protecting/supporting portions are coplanar with the attachment portions 20A and 20A, respectively, when the pair of separated base plates 20 and 20 abut each other, surfaces of the respective attachment portions 20A and 20A smoothly come into contact with each other. Thus, the boundary inclined surface 25 of the first embodiment is not necessary. However, in the second embodiment, in order to arrange the belt protecting/supporting portions 20B and 20B of the pillar anchor at a predetermined angle when the pillar anchor is seen from its side, a boundary bent line 25′ is formed between the attachment portion 20A and the belt protecting/supporting portion 20B.

Hereinafter, a method for manufacturing the pillar anchor 10′ of the present embodiment will be described with reference to FIGS. 6 and 34 to 46.

First, as a preparatory stage, a steel plate 40 is cut into an unwound form of the separated base plates 20 and 20.

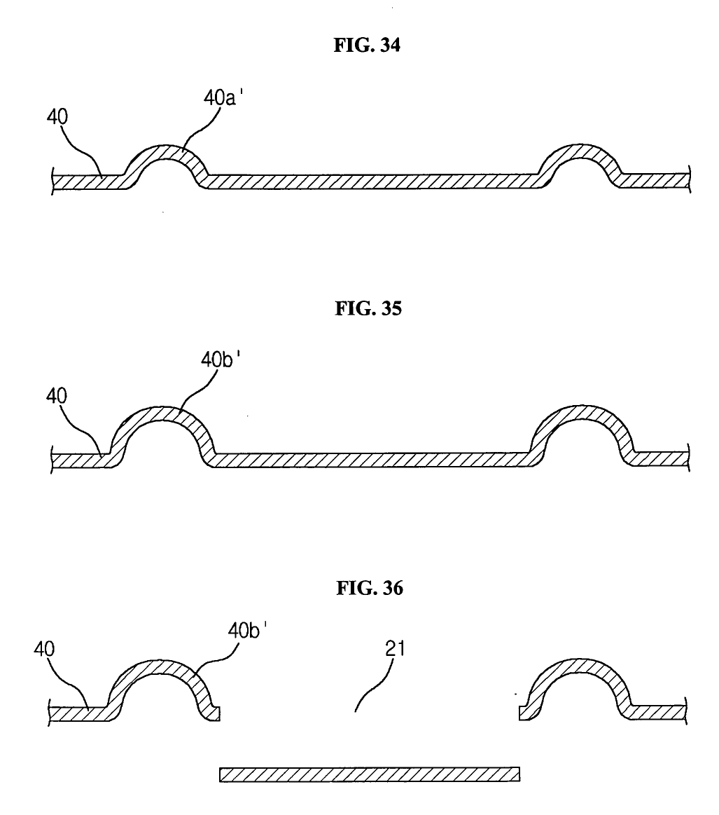

Then, in a first embossing process of the long and short peripheral portions of the belt insertion hole and a piercing process of the attachment hole as shown in FIGS. 6(a) and 34, a first convex portion 40a′ is formed by pressing up portions corresponding to the first long peripheral portion and the first and second short peripheral portions of the belt insertion hole in the steel plate 40, and at the same time, the attachment hole 22 is formed at its corresponding portion on the steel plate 40.

Next, in a second embossing process of the long and short peripheral portions of the belt insertion hole as shown in FIGS. 6(b) and 35, a second convex portion 40b′ is formed by further pressing up the first convex portion 40a′. Since a pressure load applied to the steel plate 40 can be as small as possible by dividing an embossing process into two processes, i.e., the first and second drawing processes as described above, the steel plate 40 is prevented from cracking, and at the same time, a mold is also prevented from damage, improving durability of the mold.

Then, in a piercing process of the belt insertion hole as shown in FIGS. 6(c) and 36, the belt insertion hole 21 is formed by piercing the second convex portion 40b′.

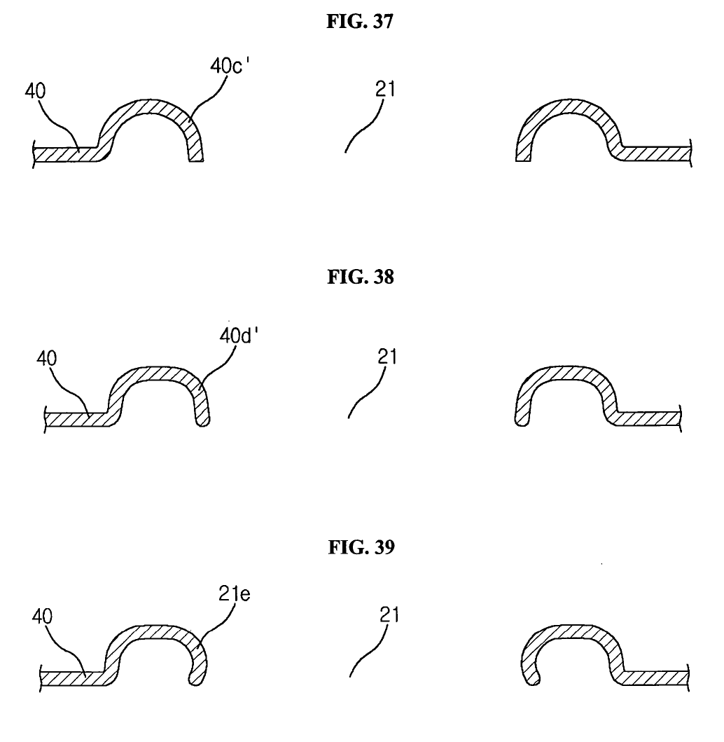

Then, in a burring process of the belt insertion hole as shown in FIGS. 6(d) and 37, a burring edge 40c′ is formed to direct a rim of the belt insertion hole 21 toward its rear side by burring the belt insertion hole 21.

Next, in a curved surface forming process as shown in FIGS. 6(e) and 38, a surface pressed edge 40d′, an edge of a distal end of which is rounded, is formed by performing surface pressing of a distal end of the burring edge 40c′, and at the same time, the edge of the distal end of the second long peripheral portion 21b is rounded by performing surface pressing of the distal end of the second long peripheral portion 21b.

Next, in a curved surface curling process as shown in FIGS. 6(f) and 39, the curved surface 21e of the belt insertion hole is formed in an arc shape by pressing the distal end of the surface pressed edge 40d′ to be curved inward.

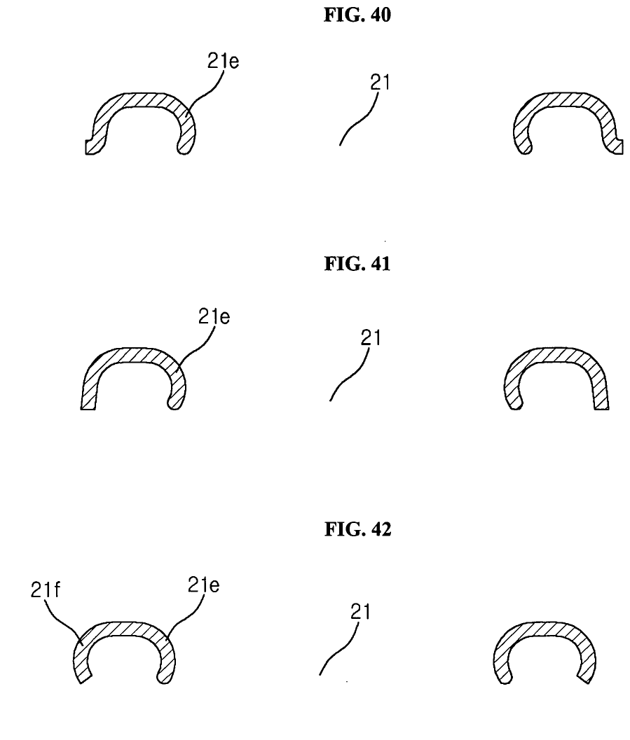

Then, in a notching process as shown in FIGS. 6(g) and 40 the pair of separated base plates 20 and 20 are formed by cutting the steel plate 40 along an outline of the attachment portions 20A and 20A except a pitch connecting portion 40e and the belt protecting/supporting portions 20B and 20B. At this time, the connecting piece 23 for connecting intermediate portions of long peripheral portion sides of the outer rims of the belt protecting/supporting portions 20B and 20B is formed.

Next, in a first bending process of the rim of the belt protecting/supporting portion as shown in FIGS. 6(h) and 41, a bending edge 40f′ is formed by bending a distal end of the rim of the belt protecting/supporting portion 20B toward its rear side.

Next, in a second bending process of the rim of the belt protecting/supporting portion as shown in FIGS. 6(i) and 42, the outline curved surface 21f of the belt protecting/supporting portion is formed by bending the rim of the belt protecting/supporting portion 20B including the bending edge 40f′ to be curved toward its rear side.

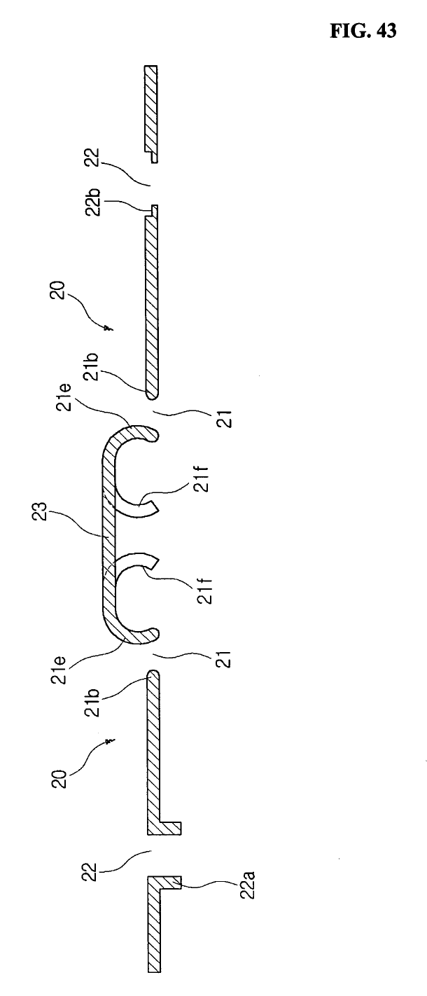

Next, in a burring and forming process of the attachment hole as shown in FIGS. 6 (j) and 43, the engaging projection 22a is formed so that a rim of the attachment hole 22 of the one of the pair of separated base plates 20 and 20 is projected toward its rear side by burring the attachment hole 22, and at the same time, the engaging depressed portion 22b is formed at a rim of the attachment hole 22 of the other of the pair of separated base plates 20 and 20 by forming the rim of the attachment hole 22.

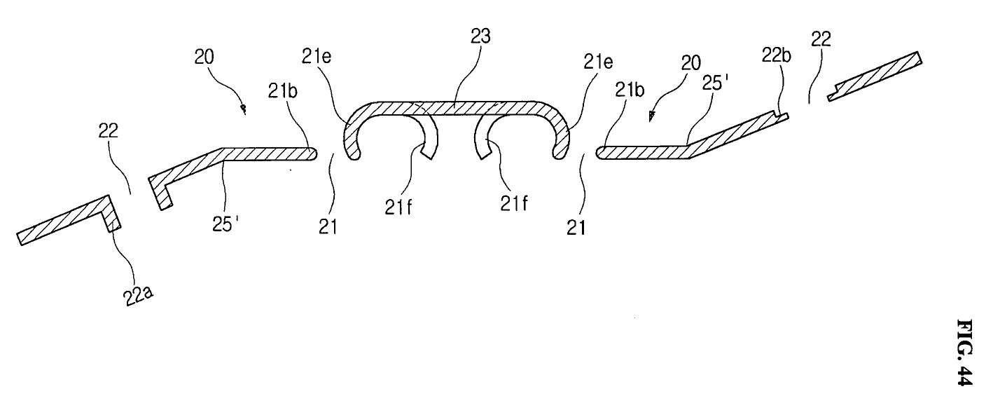

Then, in a forming process of the boundary bent line as shown in FIGS. 6(k) and 44, the boundary bent line 25 is formed between the attachment portion 20A and the belt protecting/supporting portion 20B.

Then, in a separating process as shown in FIG. 6(l), the attachment portion 20A is cut and separated from the pitch connecting portion 40e.

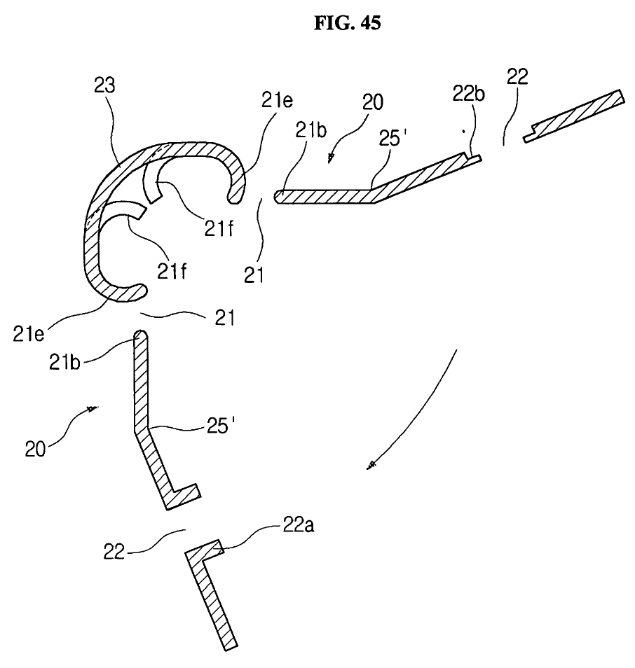

Then, in an abutting process of the separated base plates as shown in FIG. 45, the pair of separated base plates 20 and 20 abut each other so that the distal ends of the curved surfaces 21e and 21e of the belt insertion holes and the outline curved surfaces 21f and 21f of the belt protecting/supporting portions are brought into contact with each other by bending the connecting piece 23.

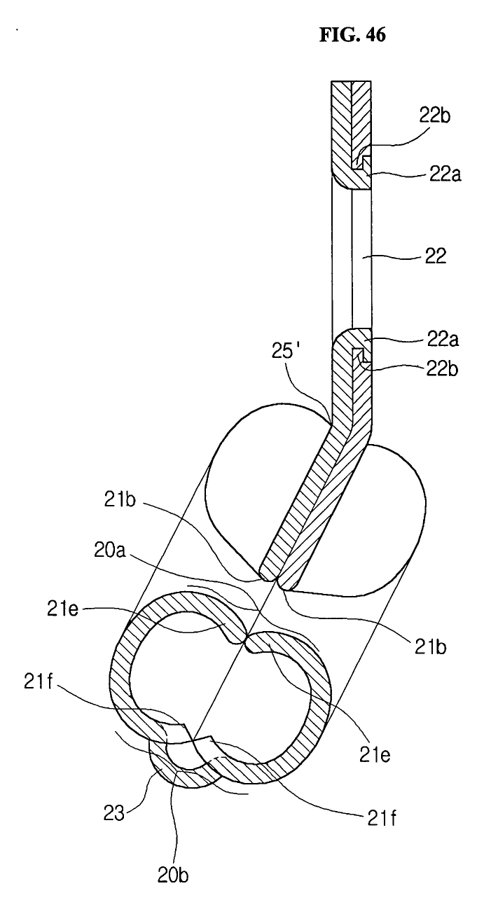

Next, in a compressing process of the attachment holes as shown in FIG. 46, the engaging projection 22a of the attachment hole 22 of the one of the pair of separated base plates 20 and 20 and the engaging depressed portion 22b of the attachment hole 22 of the other of the pair of separated base plates 20 and 20 are engaged with each other by compressing them to each other.

It is noted that modified examples illustrated in FIGS. 20 to 23, 26, and 29 may be applied to the second embodiment by the same manner as in the first embodiment.

According to the pillar anchor of the present invention described as above and the method for manufacturing the same, the rims of the pair of separated base plates abut each other, so that the surface in contact with the belt is formed in a “C”-shape. Thus, it is simple to manufacture the pillar anchor of the present invention, and moreover, the number of processes needed for manufacture is reduced. In addition, since the inner peripheral surfaces of the belt insertion holes around which the belt is wound are generally formed of only a steel plate, the friction coefficient between the belt and the inner peripheral surfaces of the belt insertion holes is reduced. Accordingly, when the belt is subjected to tension, damage caused from wear and tear of the belt due to the friction between the belt and the inner peripheral surfaces of the belt insertion holes is effectively reduced. Moreover, the belt can smoothly moves on the inner peripheral surfaces of the belt insertion holes.

The scope of the present invention is not limited to the embodiment described and illustrated above but is defined by the appended claims. It will be apparent that those skilled in the art can make various modifications and changes thereto within the scope of the invention defined by the claims. Therefore, the true scope of the present invention should be defined by the technical spirit of the appended claims.

1. A pillar anchor (10) with a web belt (S) slidably hung thereon and supported thereby, comprising:
a pair of separated base plates (20, 20) of steel abutting each other;
wherein each of the pair of separated base plates (20, 20) comprises an attachment portion (20A) and a belt protecting/supporting portion (20B);
the attachment portion (20A) is formed with an attachment hole (22) for attaching the pillar anchor (10) to a vehicle body side;
a rim of the attachment hole (22) of any one of the pair of separated base plates (20, 20) is formed with an engaging projection (22a) projected toward its rear side by a burring process;
a rim of the attachment hole (22) of the other of the pair of separated base plates (20, 20) is formed with an engaging depressed portion (22b) by a forming process;
the engaging projection (22a) of the attachment hole (22) of the one of the pair of separated base plates (20, 20) and the engaging depressed portion (22b) of the attachment hole (22) of the other of the pair of separated base plates (20, 20) are engaged to each other by a compressing process;
the belt protecting/supporting portion (20B) is formed with an elongate belt insertion hole (21) for inserting the belt (S);
first and second long peripheral portions (21a, 21b) and first and second short peripheral portions (21c, 21d) of the belt insertion hole (21) are formed into a curved surface (21e) of the belt insertion hole by a curved surface curling process after projected toward respective rear sides thereof by a burring process;
distal ends of the curved surfaces (21e, 21e) of the belt insertion holes come into contact with each other and form a belt contact portion (20a) with its cross section of an approximate “C”-shape, when the separated base plates (20, 20) abut each other;
a rim of the belt protecting/supporting portion (20B) is formed with an outline curved surface (21f) of the belt protecting/supporting portion, which is projected and curved toward its rear side by first and second bending processes;
distal ends of the outline curved surfaces (21f, 21f) of the belt protecting/supporting portions come into contact with each other and form a gripping portion (20b) the surface of which is smoothly continued, when the separated base plates (20, 20) abut each other;
edges of distal ends of the first and second long peripheral portions (21a, 21b) and the first and second short peripheral portions (21c, 21d) are rounded; and
a boundary inclined surface (25) is formed between the attachment portion (20A) and the belt protecting/supporting portion (20B).

2. A pillar anchor (10′), which a web belt (S) is slidably hung on and supported by, comprising:
a pair of separated base plates (20, 20) of steel abutting each other;
wherein each of the pair of separated base plates (20, 20) comprises an attachment portion (20A) and a belt protecting/supporting portion (20B);
the attachment portion (20A) is formed with an attachment hole (22) for attaching the pillar anchor (10) to a vehicle body side;
a rim of the attachment hole (22) of any one of the pair of separated base plates (20, 20) is formed with an engaging projection (22a) projected toward its rear side by a burring process;
a rim of the attachment hole (22) of the other of the pair of separated base plates (20, 20) is formed with an engaging depressed portion (22b) by a forming process;
the engaging projection (22a) of the attachment hole (22) of the one of the pair of separated base plates (20, 20) and the engaging depressed portion (22b) of the attachment hole (22) of the other of the pair of separated base plates (20, 20) are engaged to each other by a compressing process;
the belt protecting/supporting portion (20B) is formed with an elongate belt insertion hole (21) for inserting the belt (S);
a first long peripheral portion (21a) and first and second short peripheral portions (21c, 21d) of the belt insertion hole (21) are formed into a curved surface (21e) of the belt insertion hole by a curved surface curling process after projected toward respective front sides thereof by an embossing process;
distal ends of the curved surfaces (21e, 21e) of the belt insertion holes come into contact with each other and form a belt contact portion (20a) with its cross section of an approximate “C”-shape, when the separated base plates (20, 20) abut each other;
a rim of the belt protecting/supporting portion (20B) is formed with an outline curved surface (21f) of the belt protecting/supporting portion, which is curved convexly toward its front side by first and second bending processes;
distal ends of the outline curved surfaces (21f, 21f) of the belt protecting/supporting portions come into contact with each other and form a gripping portion (20b) the surface of which is smoothly continued, when the separated base plates (20, 20) abut each other; and
edges of distal ends of the first and second long peripheral portions (21a, 21b) and the first and second short peripheral portions (21c, 21d) are rounded.

3. The pillar anchor as claimed in claim 1 or 2, wherein the pair of separated base plates (20, 20) are engaged in order to abut each other by a connecting piece (23) formed at intermediate portions of long peripheral portion sides of the outer rims of the belt protecting/supporting portions (20B, 20B) of the respective separated base plates (20, 20).

4. The pillar anchor as claimed in claim 1 or 2, wherein the pair of separated base plates (20, 20) are engaged in order to abut each other by an edge-welded portion (120), which is formed by the edge-welding of the distal ends, at which the outline curved surfaces (21f, 21f) of the belt protecting/supporting portions come into contact with each other.

5. The pillar anchor as claimed in claim 1 or 2, wherein the pair of separated base plates (20, 20) are engaged in order to abut each other by a hook (210) and a catching hole (220) formed at intermediate portions of long peripheral portion sides of the outer rims of the belt protecting/supporting portions (20B, 20B) of the pair of separated base plates (20, 20), respectively.

6. The pillar anchor as claimed in claim 1 or 2, wherein the pair of separated base plates (20, 20) are engaged in order to abut each other by a connecting piece (23′) formed at upper ends of the attachment holes (22) of the attachment portions (20A, 20A) of the respective separated base plates (20, 20).

7. The pillar anchor as claimed in claim 1 or 2, wherein projected heights of the curved surfaces (21e, 21e) of the belt insertion holes of the respective separated base plates (20, 20) are the same, and projected heights of the outline curved surfaces (21f, 21f) of the belt protecting/supporting portions of the respective separated base plates (20, 20) are the same.

8. The pillar anchor as claimed in claim 1 or 2, wherein projected heights of the curved surface (21e) of the belt insertion hole and the outline curved surface (21f) of the belt protecting/supporting portion of any one of the pair of separated base plates (20, 20) go across a thicknesswise center line of the pillar anchor (10; 10′), and projected heights of the curved surface (21e) of the belt insertion hole and the outline curved surface (21f) of the belt protecting/supporting portion of the other of the pair of separated base plates (20, 20) do not go up to the thicknesswise center line of the pillar anchor (10; 10′).

9. A method for manufacturing the pillar anchor as claimed in claim 1, comprising:
a cutting process for cutting a steel plate (40) into an unwound form of the separated base plates (20, 20);
a first belt insertion hole drawing and attachment hole piercing process for forming a first concave portion (40a) by pressing down a portion corresponding to the belt insertion hole of the steel plate (40) and for forming the attachment hole (22) at its corresponding portion on the steel plate (40),
a second belt insertion hole drawing process for forming a second concave portion (40b) by further pressing down the first concave portion (40a);
a belt insertion hole piercing process for forming the belt insertion hole (21) by piercing the second concave portion (40b);
a belt insertion hole burring process for forming a burring projection (40c) so that a rim of the belt insertion hole (21) is projected toward its rear side by burring the belt insertion hole (21);
a curved surface forming process for performing surface pressing of a distal end of the burring projection (40c) to form a surface pressed projection (40d) with an edge of a distal end thereof being rounded;
a curved surface curling process for forming the curved surface (21e) of the belt insertion hole in an arc shape by pressing the distal end of the surface pressed projection (40d) to be curved inward;
a notching process for cutting the steel plate (40) along an outline of the attachment portion (20A) except a pitch connecting portion (40e) and the belt protecting/supporting portion (20B);
a first rim bending process for forming a bending projection (40f) by bending and projecting a distal end of a rim of the belt protecting/supporting portion (20B) to be curved toward its rear side;
a second rim bending process for forming the outline curved surface (21f) of the belt protecting/supporting portion by bending the rim of the belt protecting/supporting portion (20B) including the bending projection (40f) to be curved toward its rear side;
an attachment hole burring and forming process for forming the engaging projection (22a) so that a rim of the attachment hole (22) of the one of the pair of separated base plates (20, 20) is projected toward its rear side by burring the attachment hole (22), and for forming the engaging depressed portion (22b) at a rim of the attachment hole (22) of the other of the pair of separated base plates (20, 20) by forming the rim of the attachment hole (22);
a boundary inclined surface forming process for forming the boundary inclined surface (25) between the attachment portion (20A) and the belt protecting/supporting portion (20B);
a separating process for cutting and separating the attachment portion (20A) from the pitch connecting portion (40e);
a separated base plate abutting process for bringing the distal ends of the curved surfaces (21e, 21e) of the belt insertion holes and the outline curved surfaces (21f, 21f) of the belt protecting/supporting portions into contact with each other by causing the pair of separated base plates (20, 20) to abut each other; and
an attachment hole compressing process for causing the engaging projection (22a) of the attachment hole (22) of the one of the pair of separated base plates (20, 20) and the engaging depressed portion (22b) of the attachment hole (22) of the other of the pair of separated base plates (20, 20) to be engaged with each other by compressing them to each other.

10. A method for manufacturing the pillar anchor as claimed in claim 2, comprising:
a cutting process for cutting a steel plate (40) into an unwound form of the separated base plates (20, 20);
a first long and short peripheral portion embossing and attachment hole piercing process for forming a first convex portion (40a′) by pressing up portions corresponding to 15 the first long peripheral portion and the first and second short peripheral portions of the belt insertion hole in the steel plate (40) and for forming the attachment hole (22) at its corresponding portion on the steel plate (40);
a second long and short peripheral portion embossing process for forming a second convex portion (40b′) by further pressing up the first convex portion (40a′);
a belt insertion hole piercing process for forming the belt insertion hole (21) by piercing the second convex portion (40b′);
a belt insertion hole burring process for forming a burring edge (40c′) to direct a rim of the belt insertion hole (21) toward its rear side by burring the belt insertion hole (21);
a curved surface forming process for performing surface pressing of a distal end of the burring edge (40c′) to form a surface pressed edge (40d′) with an edge of a distal end thereof being rounded and for performing surface pressing of the distal end of the second long peripheral portion (21b) to cause the edge of the distal end of the second long peripheral portion (21b) to be rounded;
a curved surface curling process for forming the curved surface (21e) of the belt insertion hole in an arc shape by pressing the distal end of the surface pressed edge (40d′) to be curved inward;
a notching process for cutting the steel plate (40) along an outline of the attachment portion (20A) except a pitch connecting portion (40e) and the belt protecting/supporting portion (20B);
a first rim bending process for forming a bending edge (40f′) by bending a distal end of the rim of the belt protecting/supporting portion (20B) toward its rear side;
a second rim bending process for forming the outline curved surface (21f) of the belt protecting/supporting portion by bending the rim of the belt protecting/supporting portion (20B) including the bending edge (40f′) to be curved toward its rear side;
an attachment hole burring and forming process for forming the engaging projection (22a) so that a rim of the attachment hole (22) of the one of the pair of separated base plates (20, 20) is projected toward its rear side by burring the attachment hole (22), and for forming the engaging depressed portion (22b) at a rim of the attachment hole (22) of the other of the pair of separated base plates (20, 20) by forming the rim of the attachment hole (22);
a separating process for cutting and separating the attachment portion (20A) from the pitch connecting portion (40e);
a separated base plate abutting process for bringing the distal ends of the curved surfaces (21e, 21e) of the belt insertion holes and the outline curved surfaces (21f, 21f) of the belt protecting/supporting portions into contact with each other by causing the pair of separated base plates (20, 20) to abut each other; and
an attachment hole compressing process for causing the engaging projection (22a) of the attachment hole (22) of the one of the pair of separated base plates (20, 20) and the engaging depressed portion (22b) of the attachment hole (22) of the other of the pair of separated base plates (20, 20) to be engaged with each other by compressing them to each other.

11. The method as claimed in claim 9 or 10, wherein the notching process comprises the step of cutting the outline of the belt protecting/supporting portion (20B) so that the pair of separated base plates (20, 20) are connected to each other by a connecting piece (23) at intermediate portions of long peripheral portion sides of the outer rims of the belt protecting/supporting portions (20B, 20B) of the respective separated base plates (20, 20), and the separated base plate abutting process comprises the step of engaging the pair of separated base plates (20, 20) to abut each other by bending the connecting piece (23).

12. The method as claimed in claim 9 or 10, wherein the notching process comprises the step of cutting the outline of the attachment portion (20A) so that the pair of separated base plates (20, 20) are connected to each other by a connecting piece (23′) at upper ends of the attachment holes (22) of the attachment portions (20A, 20A) of the respective separated base plates (20, 20), and the separated base plate abutting process comprises the step of engaging the pair of separated base plates (20, 20) to abut each other by bending the connecting piece (23′).

13. The method as claimed in claim 9 or 10, wherein the notching process comprises the step of cutting the outline of the belt protecting/supporting portion (20B) so that the pair of separated base plates (20, 20) are connected to each other by a connecting piece (23) at intermediate portions of long peripheral portion sides of the outer rims of the belt protecting/supporting portions (20B, 20B) of the respective separated base plates (20, 20), and the separated base plate abutting process comprises the step of engaging the pair of separated base plates (20, 20) to abut each other by bending the connecting piece (23).
